(19) United States
(12) Patent Application Publication
(10) Pub. No.: US 2006/0124410 A1
(43) Pub. Date: Jun. 15, 2006

(54) Method of disk attachment to cast wheel

(76) Inventor: Kevin Linane Drage, Fulham, SA (AU)

Correspondence Address: NATH & ASSOCIATES, 112 South West Street, Alexandria, VA, 22314, US

(21) Appl. No.: 10/549,633

(22) PCT Filed: Feb. 25, 2004
(86) PCT No.: PCT/AU04/00233

§ 371 Date: Feb. 10, 2006

(30) Foreign Application Priority Data
Mar. 20, 2003 (AU) 2003901281

(51) Int. Cl. B60T 1/06

(52) U.S. Cl. 188/218 XL; 188/18 A

(57) ABSTRACT

A wheel and floating rotor disc brake assembly including a wheel having a hub with at least one projecting portion, the projecting portion having a slot formed at least a part way around thereof, the slot lying in a plane substantially normal to the axis of rotation of the wheel and parallel to the plane of rotation of the wheel. The disc brake rotor has at least one radially inward protruding tab, adapted to locate in and be fixed to the hub slot via pin elements. Axial spring clips or thrust washers are retained between the hub and the disc brake rotor by the pin elements, thereby permitting a limited degree of axial movement, or float between them.

### FIELD OF THE INVENTION

The present invention relates to a wheel and disc brake rotor assembly incorporating a simplified floating rotor assembly.

### BACKGROUND OF THE INVENTION

A floating disc brake rotor is one which is permitted a degree of movement independent of the wheel flange or hub to which it is mounted. This allows the rotor to remain parallel with the brake pads at all times, eliminating the effect of spoke or strut flex in the wheel on the disc rotor while under severe braking or cornering loads.

The advantages of floating rotors over fixed rotors include improved braking performance and feel; reduced occurrences of irregular brake pad and rotor wear, and improved heat dissipation characteristics.

Disadvantages of conventional floating rotors can include the onset of a slight knocking noise, which can be audible at low speeds, and increased complexity of construction and therefore cost. For these reasons, and the adequacy of fixed rotor disc brakes for normal driving conditions, floating rotors have traditionally been limited to performance applications.

It is an object of the invention therefore, to provide a wheel and disc brake rotor assembly incorporating a simplified floating rotor assembly, which can be produced at a reduced cost.

It is a further object of the invention to provide an attachment means between a wheel and a floating disc brake rotor, which provides for ease of assembly, and subsequent ease of rotor removal and replacement.

### BRIEF STATEMENT OF THE INVENTION

In one form of this invention although this may not necessarily be the only or indeed the broadest form of this there is proposed a wheel and floating rotor disc brake assembly including a wheel having a hub with at least one projecting portion, the projecting portion having a slot formed at least a part way around thereof, said slot lying in a plane substantially normal to the axis of rotation of the wheel and parallel to the plane of rotation of the wheel, said disc brake rotor having at least one radially inward protruding tab adapted to locate in the hub slot, and fastening means for providing floating attachment of the wheel and rotor disc.

In a preferred form of the invention there is a wheel hub having a centrally projecting portion.

In preference, the centrally projecting portion has at least two holes passing there through, each hole positioned equi distant the axis of rotation, and respective holes, and having axes substantially parallel to the axis of rotation of the hub.

In preference, the through holes are of a constant diameter to a depth, at which point the diameter is reduced so as create a shoulder.

In preference, the centrally projecting portion is locally recessed intermediate respective through holes so as to form a series of radially projecting lobes.

In preference, there is a slot passing through the outer edge of each lobe, said slot lying in a plane substantially parallel to the plane of rotation of the wheel.

In preference, there is a disc brake rotor with a concentrically positioned centre-hole passing there through, said centre-hole being sized so as to substantially accept the centrally projecting portion of the wheel hub.

In preference, there is a plurality of tabs protruding radially inwards from the inner edge of the centre-hole in the disc rotor, the number and position of tabs corresponding with the number and position of lobes on the wheel hub.

In preference, there is at least a portion of a hole passing there through each tab, said through holes being arranged so as to align with the through holes in the wheel hub.

In preference, the localised recesses in the wheel hub are adapted to provide clearance between the lobes for the radially protruding tabs of the disc brake rotor.

In preference, the depth of slot in each lobe is such that it provides a slight clearance over the thickness of the disc brake rotor.

In another form of this invention, it can be said to lie in a method of assembling a wheel hub and disc brake, wherein the centrally projecting portion of the wheel hub passes through the centre-hole of the disc brake rotor, such that the inwardly protruding tabs of the disc rotor align with the recessed portions between the lobes of the hub centre until the tabs lie in the same plane as the slots located in the hub lobes. The disc rotor is then rotated relative to the hub until the inwardly protruding tabs of the brake rotor engage the slots in the wheel hub lobes such that the holes in the tabs and the holes in the wheel hub lobes are axially aligned.

In preference, axial pins are inserted into the axially aligned bore created by the wheel hub and disc brake rotor until the end of the pin abuts the shoulder in the through hole of the hub, thereby limiting relative rotational movement between them.

In preference, an axial spring clip or thrust washer is positioned between the disc rotor and wheel hub to limit relative axial movement, or float.

In a further form of the invention, there is a wheel hub with at least two nodes projecting there from, said nodes being arranged concentrically around the axis of rotation of the wheel such that they are equi distant the axis of rotation, and each other.

In preference, each node has at least one hole passing there through, each hole having an axis substantially parallel to the axis of rotation of the hub.

In preference, there is a slot passing through the outer edge of each node, said slot lying in a plane substantially parallel to the plane of rotation of the wheel.

In another form of this invention, it can be said to lie in a method of assembling a wheel hub and disc brake, wherein the nodes of the wheel hub are passed through the recessed portion in the disc brake rotor, such that the inwardly protruding tabs of the disc are positioned between the nodes of the hub until the tabs lie in the same plane as the slots located in the hub nodes. The disc rotor is then rotated relative to the hub until the inwardly protruding tabs of the brake rotor engage the slots in the wheel hub nodes such that the holes in the nodes and the holes in the brake rotor are axially aligned.

In yet a further form of the invention, the through holes in the inward protruding tabs of the disc brake rotor are countersunk.

In preference, the thrust washers are circular waveform spring washers.

In preference, the thrust washers are seated in the counter sunk holes such that the convex face is uppermost, and the apex of the washer is substantially radially aligned with the centre of the disc brake rotor.

In another form of this invention, it can be said to lie in a method of assembling a wheel hub and disc brake where, as the tabs of the disc brake rotor are rotated relative to the hub, the orientation of the washers facilitates smooth engagement with the outer edge of the wheel lobe.

### DETAILED DESCRIPTION OF THE INVENTION

For a better understanding of this invention it will now be described with respect to preferred embodiments which shall be described with the assistance of drawings wherein;

FIG. 1 is a front elevation view of the wheel and disc brake rotor assembly in accordance with a first embodiment,

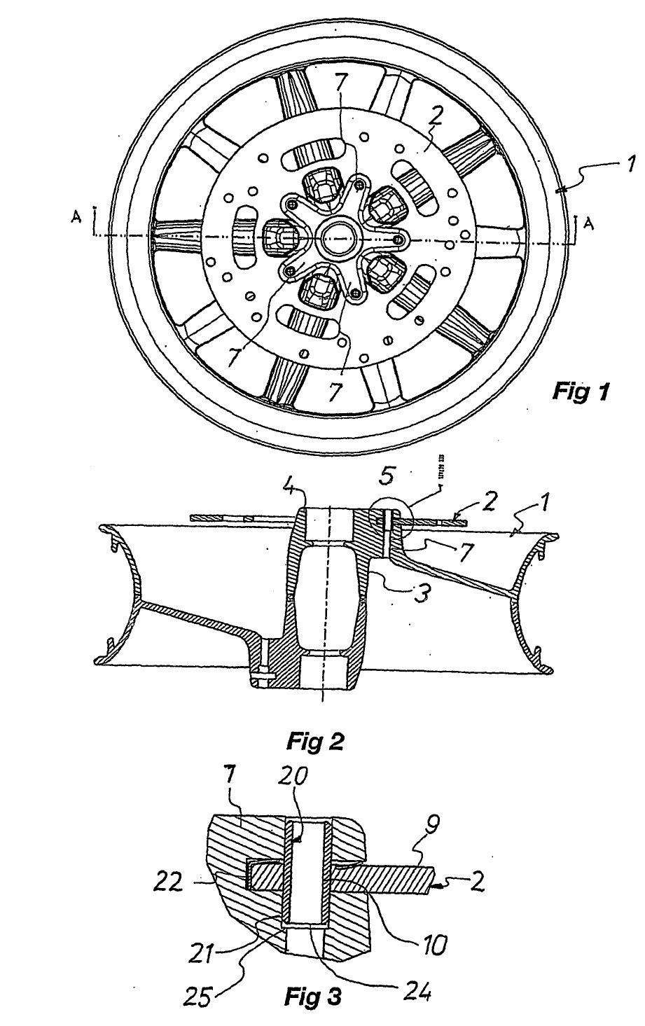

FIG. 2 is a cross sectional view through A-A of the assembly according to the first embodiment,

FIG. 3 is a detail cross sectional view of the wheel and disc brake assembly,

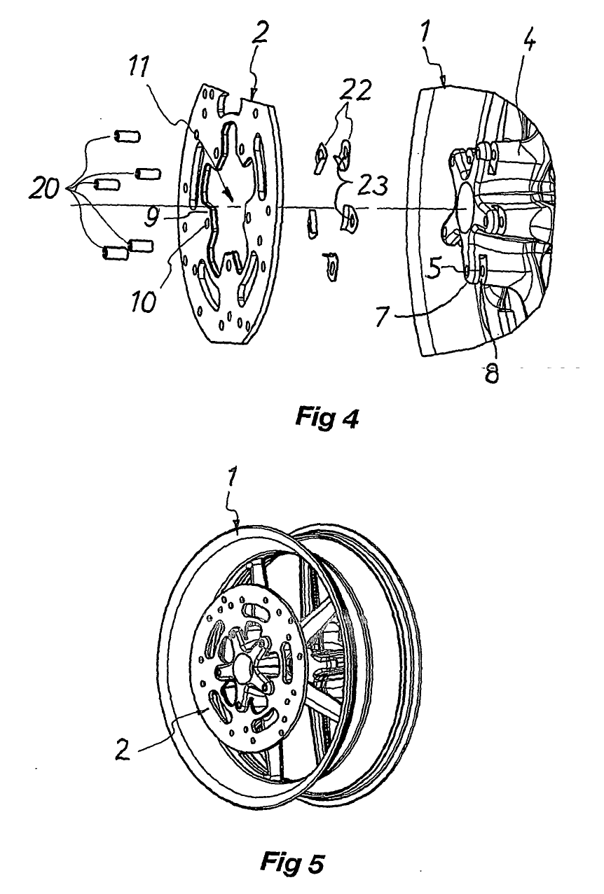

FIG. 4 is an exploded view of the components pre-assembly according to the first embodiment,

FIG. 5 is perspective view of the assembly in accordance with the first embodiment,

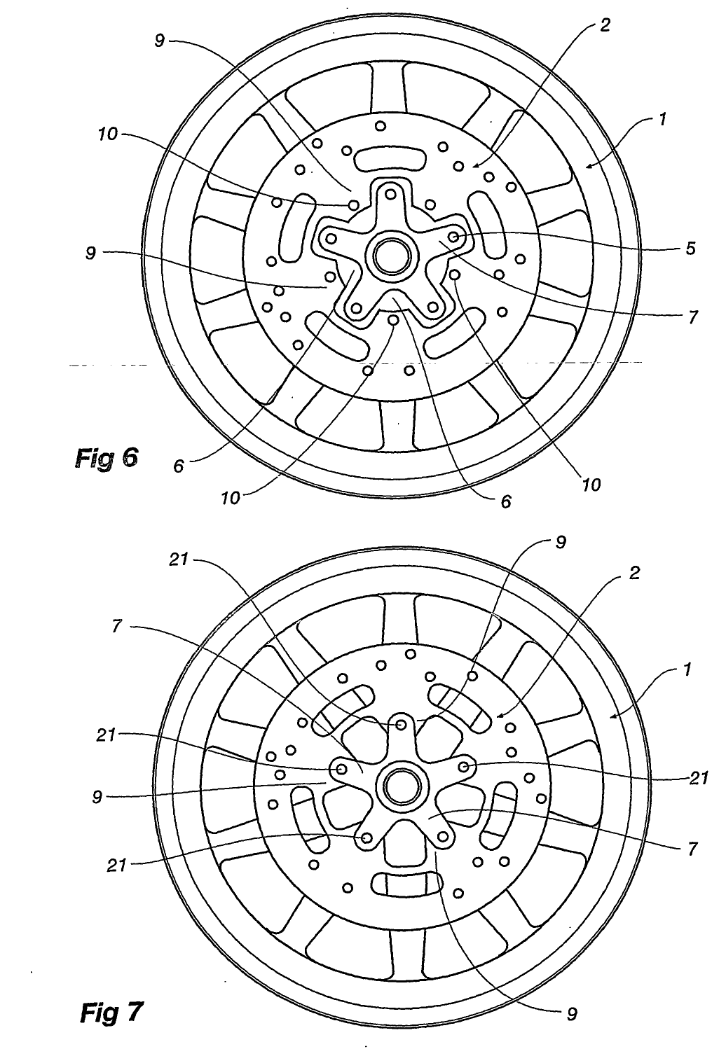

FIG. 6 is a front elevation view of the wheel and disc brake rotor in accordance with the first embodiment, pre-assembly,

FIG. 7 is a front elevation view of the wheel and disc brake rotor in accordance with the first embodiment, post-assembly,

FIG. 8 is a front elevation view of the wheel and disc brake rotor assembly in accordance with a second embodiment,

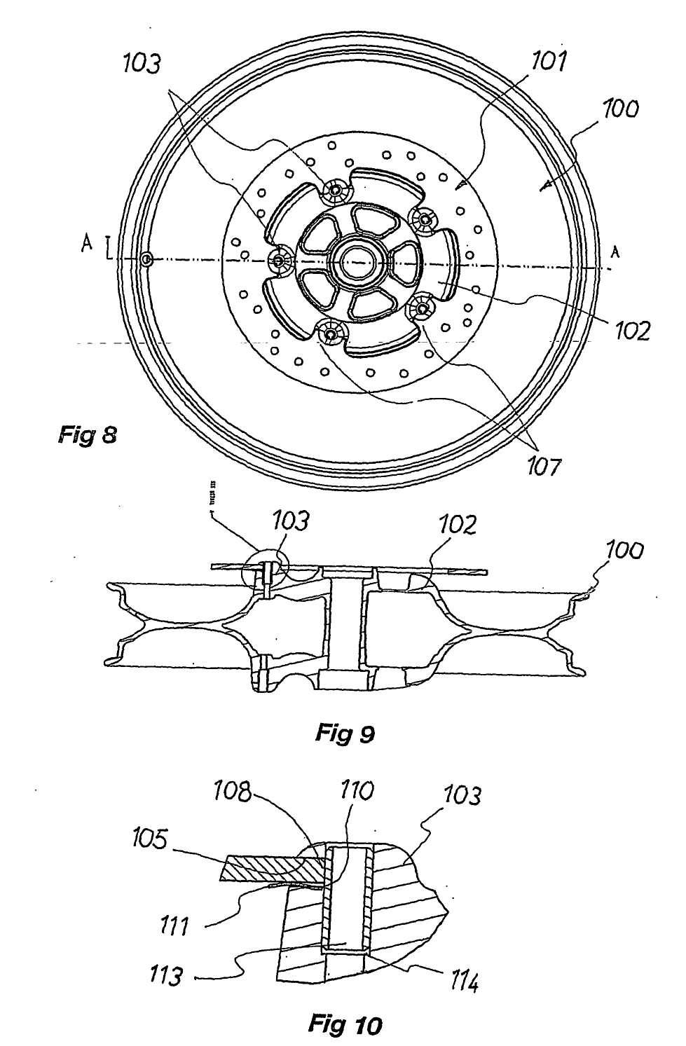

FIG. 9 is a cross sectional view through A-A of the assembly according to the second embodiment,

FIG. 10 is a detail cross sectional view of the wheel and disc brake assembly,

FIG. 11 is an exploded view of the components pre-assembly according to the second embodiment,

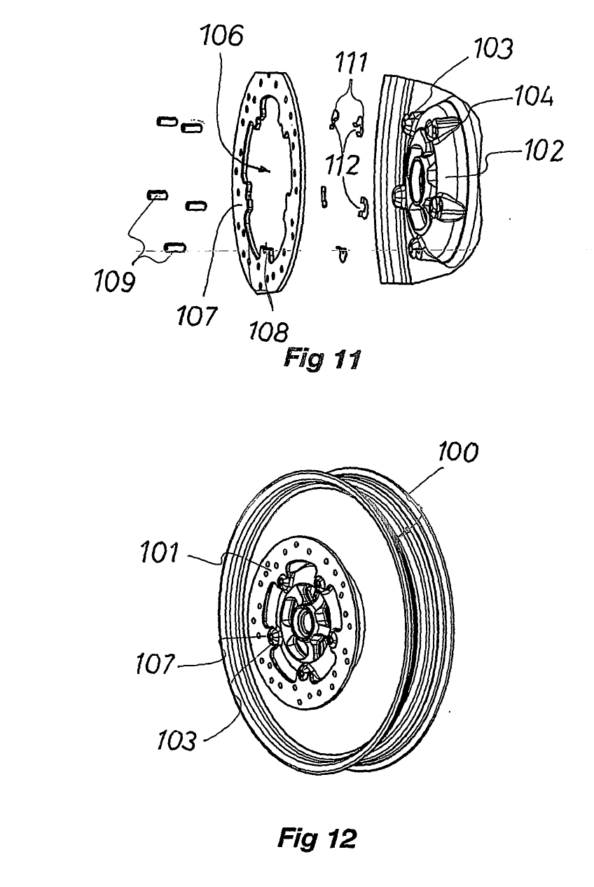

FIG. 12 is perspective view of the assembly in accordance with the second embodiment,

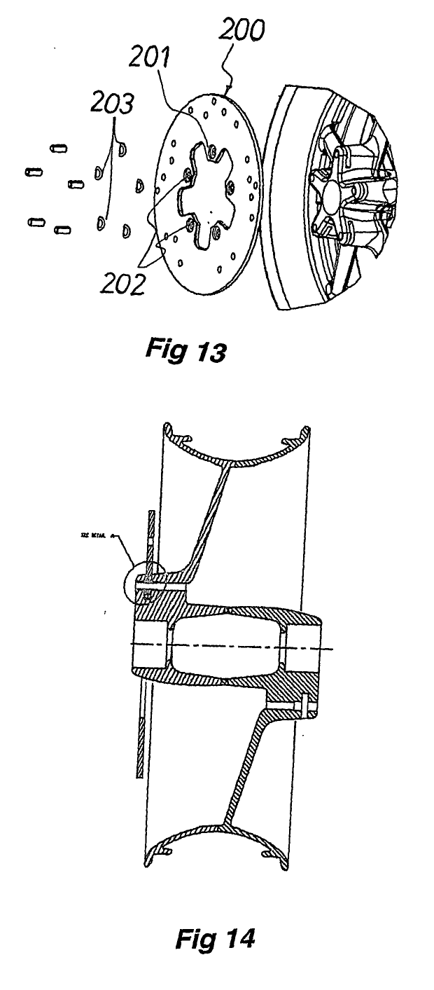

FIG. 13 is an exploded view of the components pre-assembly according to the third embodiment,

FIG. 14 is a cross sectional view through A-A of the assembly according to the third embodiment, and

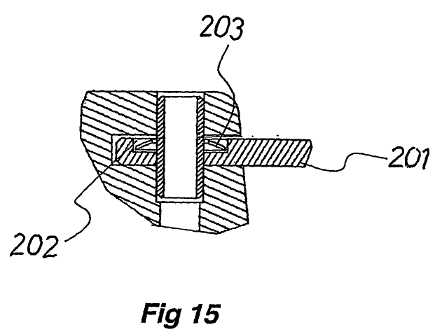

FIG. 15 is a detail cross sectional view of the wheel and disc brake assembly according to the third embodiment.

Now referring to the drawings in detail, and in particular to FIGS. 1, 2, 3, 4, 5, 6 and 7, where each of these illustrate a wheel and disc brake assembly including a wheel 1 and a disc brake rotor 2.

The wheel 1 has a hub 3 with a centrally projecting portion 4. The centrally projecting portion of the hub has a series of concentrically located holes 5 passing through it.

The centrally projecting portion 4 of the hub is locally recessed 6 intermediate respective through holes 5, so as to form a series of radially projecting lobes 7.

The lobes 7 of the hub each have a slot 8 passing there a radially outermost portion.

The disc brake rotor 2 has a concentrically positioned centre-hole 11 passing through it. This centre-hole is sized so as to substantially accept the centrally projecting portion 4 of the wheel hub 3.

There are a plurality of tabs 9 protruding radially inwards from the inner edge of the centre-hole 8 in the disc rotor. Each of these tabs 9 has a hole 10 through them. These holes are numbered and positioned so as to align with the through holes 5 in the centrally projecting portion 4 of the hub 3.

Referring now to FIGS. 6 and 7, the wheel 1 and disc 2 are assembled by first orienting the inwardly protruding tabs 9 of the disc rotor with the recessed portions 6 between the lobes 7 of the hub centre. The centrally projecting portion 4 of the wheel hub is then passed through the centre-hole 11 of the disc brake rotor, until the tabs lie in the same plane as the slots 9 located in the hub lobes. The disc rotor is then rotated relative to the hub until the inwardly protruding tabs of the brake rotor engage the slots in the wheel hub lobes such that the holes in the tabs and the holes in the brake rotor are axially aligned.

In order to effect floating attachment of the wheel 1 to the disc brake rotor 2, axial pins 20 are inserted into the axially aligned bore 21 created by the alignment of the through holes in the wheel hub 5 and the through holes 9 in the disc brake rotor, until the end of the pin 24, abuts the shoulder 25 in hole, thereby limiting relative rotational movement between them.

An advantage of this arrangement is the ease with which the wheel and disc brake can be disassembled. The pin 20 can be driven out of its bore 21 from behind using a slender tool with an end sized and adapted to pick up on the internal diameter of a hollow split pin.

A thrust washer 22 is positioned between the disc rotor and wheel hub to limit relative axial movement, or float. The thrust washer 22 has a hole 23 passing through it, such that the axial pin 20 can pass there through when the thrust washer is assembled between the wheel and the disc rotor.

Now referring to FIGS. 8, 9, 10, 11 and 12, where each of these illustrate a wheel and disc brake assembly according to a further embodiment of the invention.

The wheel 100 has a hub 102 with a plurality of nodes 103 projecting from it. Each node 103 having at least one through hole 104 passing there through.

There is a radial slot 105 passing through the radially outer edge of each node, such that the slot lies in a plane substantially parallel to the plane of the wheel.

The disc brake rotor 101 has a concentrically positioned centre-hole 106 passing there through, and a plurality of tabs 107 protruding radially inwards from the inner edge of the centre-hole in the disc rotor, the number and position of tabs corresponding with the number and position of nodes on the wheel hub.

Each tab 107, has a half-hole 108 passing there through, said holes being arranged so as to align with the through holes 104 in the wheel hub 102.

In order to effect floating attachment of the wheel 100 to the disc brake rotor 101, axial pins 109 are inserted into the axially aligned bore 110 created by the alignment of the through holes in the wheel hub and the through holes in the disc brake rotor, until the end of the pin 113 abuts the shoulder 114 in hole, thereby limiting relative rotational movement between them.

A thrust washer 111 is positioned between the disc rotor and wheel hub to limit relative axial movement, or float. The thrust washer 111 has a half hole 112 passing there through, such that the axial pin 109 can pass there through when the thrust washer is assembled between the wheel and the disc rotor.

Now referring to FIGS. 13, 14, and 15, where each of these illustrates a wheel and disc brake assembly according to a further embodiment of the invention.

The disc brake rotor 200, has a plurality of tabs 201 protruding radially inwards from the inner edge of the centre-hole in the disc rotor, the number and position of tabs corresponding with the number and position of nodes on the wheel hub. Each tab has a countersunk hole 202 passing there through.

The thrust washers 203 are seated in the countersunk holes 202.

Wheel assemblies such as those described herein would prove to be of considerable benefit in applications where the improved performance of a floating disc brake would be preferable, but the cost of known systems has proved to be prohibitive.

Throughout this specification then the purpose of the description has been to illustrate the invention and not to limit this.

1. A wheel and floating rotor disc brake assembly including a wheel having a hub with at least one projecting portion, the projecting portion having a slot formed at least a part way around thereof, said slot lying in a plane substantially normal to the axis of rotation of the wheel and parallel to the plane of rotation of the wheel, said disc brake rotor having at least one radially inward protruding tab adapted to locate in the hub slot, and fastening means for providing floating attachment of the wheel and rotor disc.

2. The wheel and floating disc brake assembly of claim 1, wherein the projecting portion of the wheel hub projects from the centre of the hub.

3. The wheel and floating disc brake assembly of claim 2, wherein the centrally projecting portion has at two holes passing through it, each hole positioned equi distant the axis of rotation, and respective holes, and having axes substantially parallel to the axis of rotation of the hub.

4. The wheel and floating disc brake assembly of claim 3, wherein the holes are of a constant diameter to a depth, at which point the diameter is reduced so as to create a shoulder.

5. The wheel and floating disc brake assembly as claim 3, wherein the centrally projecting portion is locally recessed intermediate respective holes so as to form a series of radially projecting lobes.

6. The wheel and floating disc brake assembly of claim 6, wherein the slot passes through the outer edge of each Tobe, said slot lying in-a plane substantially parallel to the plane of rotation of the wheel.

7. The wheel and floating disc brake assembly of claim 2, wherein there is a disc brake rotor with a concentrically positioned centre-hole passing there through, said centre-hole being sized so as to substantially accept the centrally projecting portion of the wheel hub.

8. The wheel and floating disc brake assembly as in claim 1, wherein there is a plurality of tabs protruding radially inwards from the inner edge of the centre-hole in the disc rotor, the number and position of tabs corresponding with the number and position of lobes on the wheel hub.

9. The wheel and floating disc brake assembly of claim 8, wherein there is at least a portion of a hole passing through each tab, said through holes being arranged so as to align with the holes in the wheel hub when assembled, in readiness to accept floating attachment means.

10. The wheel and floating disc brake assembly of claim 9, wherein the locailsed recesses in the wheel hub are adapted to provide clearance between the lobes for the radially protruding tabs of the disc brake rotor.

11. The wheel and floating disc assembly of claim 10, wherein the depth of radial slot in each lobe is such that it provides a slight clearance over the thickness of the disc brake rotor.

12. The wheel and floating disc assembly of claim 9, wherein the floating attachment means Incdude axial pins inserted into the axially aligned bores created by the wheel hub and disc brake rotor until the end of the pin abuts the shoulder In the through hole of the hub, thereby limiting relative rotational movement between them.

13. The wheel and floating disc assembly of claim 12, wherein there is a means to limit relative axial movement or float positioned between the disc rotor and wheel hub.

14. The wheel and floating disc assembly of claim 13, wherein the means to limit relative axial movement or float has a hole passing through it, the hole being sized and adapted to accept an axial pin.

15. The wheel and floating disc assembly of claim 14, wherein the means for limiting axial movement or float between the disc rotor and wheel hub Is an axial spring dip.

16. The wheel and floating disc assembly of claim 14, wherein the means for limiting axial movement or float between the disc rotor and wheel hub is a thrust washer.

17. A method of assembling a wheel hub and disc brake, wherein the centrally projecting portion of the wheel hub passes through the centre-hole of the disc brake rotor, such that the inwardly protruding tabs of the disc rotor align with the recessed portions between the lobes of the hub centre until the tabs lie in the same plane as the slots located in the hub lobes, the disc rotor is then rotated relative to the hub until the inwardly protruding tabs of the brake rotor engage the slots in the wheel hub lobes such that the holes in the tabs and the holes in the brake rotor are axially aligned in readiness to accept floating attachment means.

18. The method of claim 17 wherein means for limiting axial movement or float is positioned between the wheel hub and disc bake, such that holes in the means for limiting axial movement or float align with the holes in the wheel hub and disk break.

19. The method of claim 18, wherein the floating attachment means include axial pins Inserted Into the axially aligned bores created by the wheel hub, means for limiting axial movement or float and the disc brake rotor, thereby limiting relative rotational movement between them.

20. The wheel and floating rotor disc brake assembly of claim 1, wherein there are at least two projecting portions arranged concentically around the axis of rotation of the wheel such that they are equi distant the axis of rotation, and each other.

21. The wheel and floating rotor disc brake assembly of claim 20, wherein the projecting portions are nodes.

22. The wheel and floating rotor disc brake assembly of claim 21, wherein each node has at least one hole penetrating therein, each hole having an axis substantially parallel to the axis of rotation of the hub.

23. The wheel and floating rotor disc brake assembly of claim 22, wherein there is a radial slot passing through at least a portion of the outer edge of each node, said slot lying in a plane substantially parallel to the plane of rotation of the wheel.

24. A method of assembling a wheel hub and disc brake, wherein the nodes of the wheel hub are passed through the recessed portion in the disc brake rotor, such that the inwardly protruding tabs of the disc are positioned between the nodes of the hub until the tabs lie in the same plane as the slots located In the hub nodes. The disc rotor Is then rotated relative to the hub until the inwardly protruding tabs of the brake rotor engage the slots In the wheel hub nodes-such that the holes In the nodes and the holes In the brake rotor are axially aligned.

25. The method of claim 24 wherein means for limiting axial movement or float is positioned between the wheel hub and disc brake, such that holes In the means for limiting axial movement or float align with the holes In the wheel hub and disc brake.

26. The method of claim 25, wherein the floating attachment means Include axial pins Inserted into the axially aligned bores created by the wheel hub, means for limiting axial movement or float and disc brake rotor, thereby limiting relative rotational movement between them.

27. The wheel and floating rotor disc brake assembly as in claim 1, wherein the through holes in the inward protruding tabs of the disc brake rotor are countersunk, so that thrust washers can be seated in the countersunk holes.

28. The wheel and floating rotor disc brake assembly of claim 27, wherein the thrust washers are circular waveform spring washers.

29. The wheel and floating rotor disc brake assembly of claim 28, wherein the washers are seated In the countersunk holes such that the convex face of the washer is uppermost, and the apex of the washer is substantially radially aligned with the centre of the disc brake rotor prior to assembly, so as to facilitate smooth engagement of the washer with the outer edge of the wheel lobe during assembly.

30. (canceled)

31. (canceled)
